(19) United States
(12) Patent Application Publication
(10) Pub. No.: US 2023/0278831 A1
(43) Pub. Date: Sep. 7, 2023

(54) ULTRACAPACITOR POWERED CONSTRUCTION ELEVATOR

(71) Applicant: BRANDSAFWAY SERVICES LLC, Kennesaw, GA (US)

(72) Inventor: Todd Rego, Saddle Brook, NJ (US)

(21) Appl. No.: 18/177,655

(22) Filed: Mar. 2, 2023

Related U.S. Application Data
(60) Provisional application No. 63/268,837, filed on Mar. 3, 2022.

(51) Int. Cl. B66B 11/04; B66B 11/00

(52) U.S. Cl. CPC B66B 11/043; B66B 11/0025; B66B 11/005

(57) ABSTRACT

A construction elevator is provided. The construction elevator may include a car controller configured to direct the construction elevator to operate in a lifting operation or a descending operation. The construction elevator may further include a variable frequency drive coupled to a motor that are configured to operate the construction elevator in the lifting operation or the descending operation responsive to the direction of the car controller. Moreover, the construction elevator may include an onboard power source configured to provide power to the variable frequency drive and the motor to complete the lifting operation without needing to be recharged by an external power supply.

### CROSS-REFERENCE TO RELATED APPLICATIONS

This application claims the benefit of the filing date of U.S. Provisional Application Ser. No. 63/268,837 filed Mar. 3, 2022, entitled, “Ultracapacitor Powered Construction Elevator”, which is hereby incorporated by reference as if fully set forth herein.

### FIELD OF THE INVENTION

This disclosure generally relates to construction elevators. In particular, the disclosure relates to an ultracapacitor powered construction elevator and accompanying charging systems.

### BACKGROUND OF THE INVENTION

Construction elevators are used throughout the construction industry to move people and materials to different floors of a building being constructed. The temporary nature of construction elevators has posed difficulties in providing a consistent reliable power source for their operation.

Known solutions include using a long power cable tied to a ground-based power supply and an energizeable busbar running along the exterior length of the building being constructed. However, both solutions have issues that make their use problematic and/or inconvenient.

For example, the power cable may need to be raised when the elevator is jumped, require installation of wind brackets and a trolley system that may malfunction and/or break the power cable, may hang up on components when it is windy causing the power cable to break, and/or may be insufficient for use on taller buildings due to size and weight requirements for those applications.

Likewise, for the busbar, power may need to be turned off before additional sections may be added to the busbar or the busbar may become inoperable from icing over in the winter, hot and cold expansion, pulling apart of connectors, or part wear and tear. Further, busbar use is prohibited in some jurisdictions.

Batteries are one other potential power source besides the busbar and power cable. However, batteries also have several limitations. Recharge limits and diminishing capacity over time for battery systems capable of powering a construction elevator make them a non-ideal power source.

Considering the foregoing, there is a clear need for improved power sources for construction elevators.

### SUMMARY OF THE INVENTION

A first aspect of this disclosure pertains to a construction elevator comprising a car controller configured to direct the construction elevator to operate in a lifting operation or a descending operation; a variable frequency drive coupled to a motor that are configured to operate the construction elevator in the lifting operation or the descending operation responsive to the direction of the car controller; and an onboard power source configured to provide power to the variable frequency drive and the motor to complete the lifting operation without the construction elevator needing to be powered by an external power supply.

A second aspect of this disclosure pertains to the construction elevator of the first aspect, wherein the onboard power source includes at least one ultracapacitor.

A third aspect of this disclosure pertains to the construction elevator of the first aspect, wherein the onboard power source includes a plurality of ultracapacitors.

A fourth aspect of this disclosure pertains to the construction elevator of the first aspect, wherein the variable frequency drive and the motor are configured to recharge the onboard power source when the construction elevator is in the descending operation.

A fifth aspect of this disclosure pertains to the construction elevator of the first aspect further comprising a booster configured to boost the power output from the onboard power source to an operating voltage of the variable frequency drive.

A sixth aspect of this disclosure pertains to the construction elevator of the first aspect further comprising a brake chopper configured to shunt excess power output by the variable frequency drive above a preconfigured voltage threshold to a resistor.

A seventh aspect of this disclosure pertains to the construction elevator of the first aspect, wherein the onboard power source is configured to receive power from a charging interface.

An eighth aspect of this disclosure pertains to the construction elevator of the seventh aspect, wherein the construction elevator is configured to traverse from a first position to a second position, and wherein the onboard power source is configured to receive power from the charging interface when the construction elevator is positioned at the first position but not when the construction elevator is positioned at the second position.

A nineth aspect of this disclosure pertains to a method for operating a construction elevator comprising charging a power source onboard the construction elevator when the construction elevator is positioned at a first position; and elevating the construction elevator to a second position without the construction elevator receiving power from an external source.

A tenth aspect of this disclosure pertains to the method of the nineth aspect further comprising using an ultracapacitor as the power source onboard the construction elevator.

An eleventh aspect of this disclosure pertains to the method of the nineth aspect further comprising using a plurality of ultracapacitors as the power source onboard the construction elevator.

A twelfth aspect of this disclosure pertains to the method of the nineth aspect further comprising recharging the power source onboard the construction elevator when the construction elevator descends from an elevated position.

A thirteenth aspect of this disclosure pertains to the method of the twelfth aspect, wherein the recharging further comprising generating power by a motor onboard the construction elevator and recharging the power source onboard the construction elevator with the power generated by the motor onboard the construction elevator.

A fourteenth aspect of this disclosure pertains to the method of the twelfth aspect further comprising shunting excess power when the power source onboard the construction elevator is recharged above a preconfigured threshold.

A fifteenth aspect of this disclosure pertains to the method of the ninth aspect, wherein the charging the power source onboard the construction elevator further comprises the power source receiving power from a charging interface.

A sixteenth aspect of this disclosure pertains to the method of the fifteenth aspect, wherein the receiving power from the charging interface further comprises the power source onboard the construction elevator receiving power from the charging interface when the construction elevator is positioned at the first position, but not when the construction elevator is positioned at the second position.

A seventeenth aspect of this disclosure pertains to a construction elevator comprising a car controller configured to direct the construction elevator to operate in a lifting operation or a descending operation. It further includes a motor configured to operate the construction elevator in the lifting operation or the descending operation responsive to an instruction of the car controller without receiving power from a power supply external to the construction elevator.

An eighteenth aspect of this disclosure pertains to the construction elevator of the seventeenth aspect, wherein the construction elevator further comprises an onboard power source configured to power the motor.

A nineteenth aspect of this disclosure pertains to the construction elevator of the eighteenth aspect wherein the onboard power source includes at least one ultracapacitor.

A twentieth aspect of this disclosure pertains to the construction elevator of the nineteenth aspect, wherein the motor is configured to recharge the onboard power source when the construction elevator is in the descending operation.

### BRIEF DESCRIPTION OF THE DRAWINGS

FIG. 1 illustrates a schematic view of a construction site according to an embodiment; and

FIG. 2 illustrates a block diagram of a control system for a construction elevator according to an embodiment.

Before explaining the disclosed embodiment of the present invention in detail, it is to be understood that the invention is not limited in its application to the details of the particular arrangement shown, since the invention is capable of other embodiments. Exemplary embodiments are illustrated in referenced figures of the drawings. It is intended that the embodiments and figures disclosed herein are to be considered illustrative rather than limiting. Also, the terminology used herein is for the purpose of description and not of limitation.

### DETAILED DESCRIPTION OF THE DRAWINGS

While this invention is susceptible of embodiments in many different forms, there are shown in the drawings and will be described in detail herein specific embodiments with the understanding that the present disclosure is an exemplification of the principles of the invention. It is not intended to limit the invention to the specific illustrated embodiments. The features of the invention disclosed herein in the description, drawings, and claims may be significant, both individually and in any desired combinations, for the operation of the invention in its various embodiments. Features from one embodiment may be used in other embodiments of the invention.

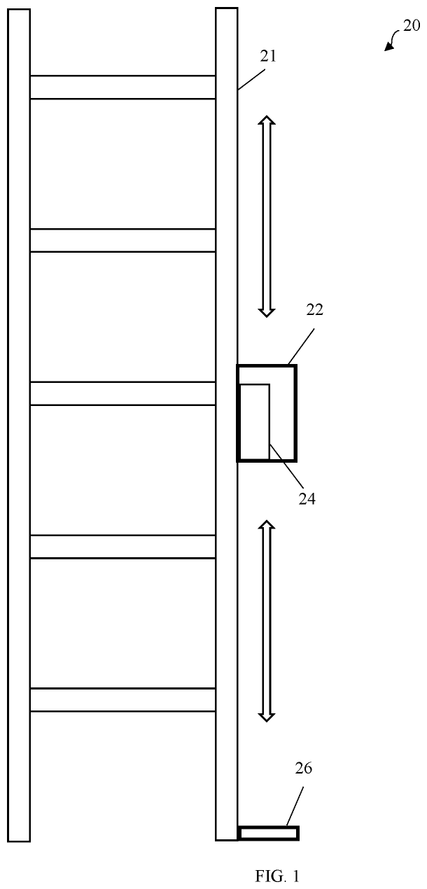

FIG. 1 illustrates a schematic view of a construction site 20 according to an embodiment. The construction site 20 may include a building 21 that is under construction and a construction elevator (hoist, lift, etc.) 22 coupled to the building 21 for use in moving materials and/or people to different levels of the building 21.

The construction elevator 22 may include an onboard power source 24 that may be configured to supply sufficient power to mechanically lift the construction elevator 22 from a first position to a second position that is elevated relative to the first position and back to the first position without needing to be recharged by an external power supply. For example, in some embodiments, the first position may include a ground level and the second position may include a top of the building 21. However, other examples for the first and second positions are also contemplated herein.

Further still, the construction site 20 may include a charging interface 26. The charging interface 26 may be configured to charge and power the onboard power source 24 when the onboard power source 24 is positioned in a charging position. When in the charging position, such as when the construction elevator 22 is in the first position or on the ground level, the onboard power source 24 may be electrically coupled to the charging interface 26 and the onboard power source 24 may be charged or recharged by the charging interface 26. In some embodiments, the charging position may include the first position.

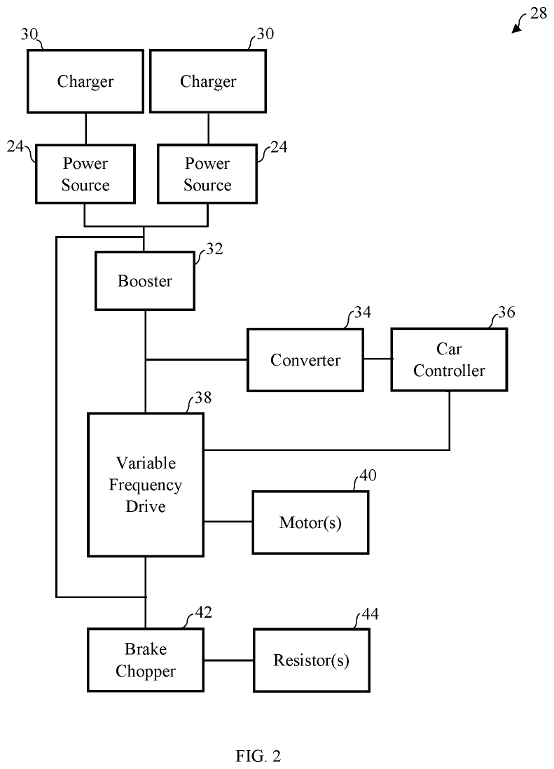

FIG. 2 illustrates a block diagram of a control system 28 for the construction elevator 22. The control system 28 may include one or more of the onboard power sources 24. Moreover, one or more chargers 30 may be electrically coupled to the onboard power source 24. In some embodiments, the chargers 30 may be in a form of a A/C to D/C converter or charger. In some embodiments, each onboard power source 24 may be paired with one charger 30. In other embodiments, one charger 30 may be configured to charge multiple onboard power sources 24.

The control system 28 may further include a booster 32 electrically coupled to the onboard power source 24. In some embodiments, the booster 32 may be in a form of a buck booster although other booster types are also contemplated herein. The booster 32 may be electronically coupled to a converter 34, which may be further electrically coupled to a car controller 36. In some embodiments, the booster 32 may be in a form of a D/C to A/C converter. The car controller 36 may further be electrically coupled to a variable frequency drive (VFD) 38.

Moreover, the booster 32 may also be electrically coupled to the VFD 38. Further still, the VFD 38 may be electrically coupled to one or more motors 40. The motors 40 may be in a form of an A/C motor, or other suitable motors known in the art.

The VFD 38 may further be electrically coupled to a brake chopper 42, which may be electrically coupled to one or more resistors 44. In addition, the brake chopper 42 may also be electrically coupled to the power source 24.

In some embodiments, the control system 28 may be contained partially or entirely within the construction elevator 22. In these embodiments, the charging interface 26 may include an interface that electrically couples the chargers 30 housed in the construction elevator 22 to an external power supply (not shown). For example, the charging interface 26 may electrically couple with the chargers 30 through induction, magnetic resonance, electrical field coupling, or other wireless charging methods. Alternatively or additionally, the charging interface 26 may be electrically coupled to the chargers 30 through direct contacts such as through one or more ports or interfaces.

In further embodiments, embodiments, the chargers 30 may be contained within the charging interface 26. In these embodiments, the chargers 30 may include an interface that electrically couples the chargers 30 to the onboard power source 24. For example, the chargers 30 may electrically couple with the onboard power source 24 through induction, magnetic resonance, electrical field coupling, or other wireless charging methods. Alternatively or additionally, the chargers 30 may be electrically coupled to the onboard power source 24 through direct contacts, such as through one or more ports or interfaces.

In some embodiments, the onboard power source 24 may include a plurality of ultracapacitors. When fully charged, the ultracapacitors may be sufficient to provide power to mechanically lift the construction elevator 22 from the first position to the second position of the building 21 and back to the first position without needing to be recharged by an external power supply. The plurality of ultracapacitors may each have a capacitance between about 100 farads to about 200 farads, a working voltage between about 40 volts to about 80 volts, and power rating between about 60 watt hours and 100 watt hours. In some embodiments, the plurality of ultracapacitors may each have a capacitance of about 141 farads, a working voltage of about 64 volts, and power rating of about 80 watt hours.

Ultracapacitors may provide several advantages as a power storage and distribution medium as compared to conventional batteries. For example, ultracapacitors may be good for around two million charge cycles with minimal degradation in capacity and may be charged to capacity very quickly (e.g. in approximately 30 seconds). These advantages may be especially useful when used in conjunction with construction elevators such as the construction elevator 22 because the typical operation of construction elevators may result in up to 75 charging cycles a day and/or require quick recharge times to prevent long elevator downtimes. In embodiments where the onboard power source 24 include ultracapacitors, the ultracapacitor may be arranged in one or more shelves within the construction elevator 22. Alternatively or additionally, the ultracapacitors may be provided along a bottom or a top of the construction elevator 22.

Operations of the construction elevator 22 may include a charging operation, a lifting operation, and a descending operation, which will be described in more details herein.

In the charging operation, the construction elevator 22 may be positioned at the charging position and may be electrically coupled with the charging interface 26. Power from the charging interface 26 (such as three phase A/C power) may be fed into the into the chargers 30.

Next, the chargers 30 may convert the applied power into a desired current type. For example, if A/C power is applied from the charging interface 26 to the chargers 30, the chargers 30 may convert the A/C power into D/C power.

Therefrom, the chargers 30 may feed the power to the onboard power source 24 to recharge the onboard power source 24 partially or to full capacity. In some embodiments, the current type may not need to be converted before the power is feed to the onboard power source 24, in which case, a converter within the chargers 30 may be omitted. In further embodiments where the charging interface 26 may be configured to charge the onboard power sources 24, the chargers 30 may be omitted altogether.

In the lifting operation, the onboard power source 24 may be configured to output the stored power from the charging operation to the booster 32. The booster 32 may then boost the power supplied by the onboard power source 24 to an operating voltage for the VFD 38, which may then be fed to an internal bus in the VFD 38 and to the car controller 36. In embodiments where the booster 32 is outputting D/C power, the converter 34 may convert the D/C power into A/C power before feeding the power to the car controller 36. Alternatively, the converter 34 may be omitted in embodiments where such conversion is not needed. After receiving the boosted power from the booster 32, the VFD 38 may operate the motors 40 to drive the construction elevator 22 upward until the car controller 36 terminates the lifting operation.

In the descending operation where the construction elevator 22 is moving in a downward direction, the construction elevator 22 may generate power that is fed back into the onboard power source 24 to at least partially recharge the onboard power source 24. For example, in some embodiments, about 50% to about 75% of the power used in the lifting operation may be reclaimed during the descending operation. In some embodiments, reverse movement of the motors 40 in conjunction with the VFD 38 from the descending operation may produce the reclaimed power used to recharge the onboard power source 24.

When the descending operation is in progress and the onboard power source 24 is fully charged, the brake chopper 42 may be activated to shunt the excess power generated from the descending operation to the resistor 44 where the resistor 44 will dissipate the excess power as heat. In some embodiments, the brake chopper 42 may be automatically configured to activate when the voltage on the combined electrical connection with the VFD 38 and the onboard power source 24 exceeds a preconfigured threshold voltage level. In additional embodiments, the power generated during the descending operation and/or the excess power may otherwise be utilized by the construction elevator 22, such as to power a light or other devices.

Furthermore, in some embodiments, the car controller 36 may be configured to provide operating commands to the VFD 38, such as to initiate the lifting and/or the descending operations described herein such that the construction elevator 22 may move up and down the building 21 to pick up and drop off passengers and/or material at different levels.

In further embodiments, the construction elevator 22 may draw power from the building 21 and the onboard power source 24 may be used to supplement power supplied from the building 21. For example, the building 21 may supply power to the construction elevator 22 through one or more cables or busbars, while the construction elevator 22 may also draw additional power from the onboard power source 24.

In some embodiments, the construction elevator 22 may require a power level that exceeds what the building 21 may supply, such as exceeding an amperage that may be supplied by the building 21. In such embodiments, the onboard power source 24 may supplement the construction elevator 22 with additional power in addition to the power supplied by the building 21. In embodiments where the onboard power source 24 includes a plurality of ultracapacitors, the construction elevator 22 may utilize just one ultracapacitor, a subset, or all of the plurality of ultracapacitors, depending on an amount of power needed by the construction elevator 22. Moreover, in embodiments where the construction elevator 22 is configured to draw power from the building 21 in addition to the onboard power source 24, the onboard power source 24 may be charged and/or recharged during the descending operation as previously described, and/or while the construction elevator 22 is stationary at any or some of the positions on the building 21.

Although several embodiments have been described in detail above, other modifications are possible. For example, other components may be added to or removed from the described systems, and other embodiments may be within the scope of the invention.

From the foregoing, it will be observed that numerous variations and modifications may be affected without departing from the spirit and scope of the invention. It is to be understood that no limitation with respect to the specific system or method described herein is intended or should be inferred. It is, of course, intended to cover all such modifications as fall within the spirit and scope of the invention.

What is claimed is:

1. A construction elevator comprising:
a car controller configured to direct the construction elevator to operate in a lifting operation or a descending operation;
a variable frequency drive coupled to a motor that are configured to operate the construction elevator in the lifting operation or the descending operation responsive to an instruction of the car controller; and
an onboard power source configured to provide power to the variable frequency drive and the motor to complete the lifting operation without the construction elevator needing to be powered by an external power supply.

2. The construction elevator of claim 1, wherein the onboard power source includes at least one ultracapacitor.

3. The construction elevator of claim 1, wherein the onboard power source includes a plurality of ultracapacitors.

4. The construction elevator of claim 1, wherein the variable frequency drive and the motor are configured to recharge the onboard power source when the construction elevator is in the descending operation.

5. The construction elevator of claim 1 further comprising a booster configured to boost the power output from the onboard power source to an operating voltage of the variable frequency drive.

6. The construction elevator of claim 1 further comprising a brake chopper configured to shunt excess power output by the variable frequency drive above a preconfigured voltage threshold to a resistor.

7. The construction elevator of claim 1, wherein the onboard power source is configured to receive power from a charging interface.

8. The construction elevator of claim 7, wherein the construction elevator is configured to traverse from a first position to a second position, and
wherein the onboard power source is configured to receive power from the charging interface when the construction elevator is positioned at the first position but not when the construction elevator is positioned at the second position.

9. A method for operating a construction elevator comprising:
charging a power source onboard the construction elevator when the construction elevator is positioned at a first position; and
elevating the construction elevator to a second position without the construction elevator receiving power from an external source.

10. The method for operating a construction elevator of claim 9 further comprising using an ultracapacitor as the power source onboard the construction elevator.

11. The method for operating a construction elevator of claim 9 further comprising using a plurality of ultracapacitors as the power source onboard the construction elevator.

12. The method for operating a construction elevator of claim 9 further comprising recharging the power source onboard the construction elevator when the construction elevator descends from an elevated position.

13. The method for operating a construction elevator of claim 12, wherein the recharging further comprises:
generating power by a motor onboard the construction elevator; and
recharging the power source onboard the construction elevator with the power generated by the motor onboard the construction elevator.

14. The method for operating a construction elevator of claim 12 further comprising shunting excess power when the power source onboard the construction elevator is recharged above a preconfigured threshold.

15. The method for operating a construction elevator of claim 9, wherein the charging the power source onboard the construction elevator further comprises the power source onboard the construction elevator receiving power from a charging interface.

16. The method for operating a construction elevator of claim 15, wherein the receiving power from the charging interface further comprises the power source onboard the construction elevator receiving power from the charging interface when the construction elevator is positioned at the first position but not when the construction elevator is positioned at the second position.

17. A construction elevator comprising:
a car controller configured to direct the construction elevator to operate in a lifting operation or a descending operation; and
a motor configured to operate the construction elevator in the lifting operation or the descending operation responsive to an instruction of the car controller without receiving power from a power supply external to the construction elevator.

18. The construction elevator of claim 17, wherein the construction elevator further comprises an onboard power source configured to power the motor.

19. The construction elevator of claim 18, wherein the onboard power source includes at least one ultracapacitor.

20. The construction elevator of claim 19, wherein the motor is configured to recharge the onboard power source when the construction elevator is in the descending operation.
